(19) United States
(12) Patent Application Publication
(10) Pub. No.: US 2025/0337282 A1
(43) Pub. Date: Oct. 30, 2025

(54) SYSTEMS AND METHOD FOR WORLDWIDE ENERGY MATRIX (WEM)

(71) Applicant: Emrod Limited, Auckland (NZ)

(72) Inventors: Zvi KUSHNIR, Auckland (NZ); Raymond Andrew SIMPKIN, Auckland (NZ)

(73) Assignee: Emrod Limited, Auckland (NZ)

(21) Appl. No.: 18/870,160

(22) PCT Filed: May 31, 2023
(86) PCT No.: PCT/IB2023/055606

§ 371 Date: Nov. 27, 2024

Related U.S. Application Data
(60) Provisional application No. 63/347,749, filed on Jun. 1, 2022.

(51) Int. Cl. H02J 50/23; B64G 1/10; B64G 1/42; H02J 50/00; H02J 50/27; H02J 50/40

(52) U.S. Cl. CPC H02J 50/23; B64G 1/1085; B64G 1/4282; H02J 50/005; H02J 50/27; H02J 50/40

(57) ABSTRACT

A relay for a beam of wireless power and a satellite with the relay are disclosed. The relay includes: an array of coaxial waveguide elements, each element including: an input polarizing section, an output polarizing section, and a phase shifting section located between said input and output polarizing sections, wherein said input polarizing section, said output polarizing section, and said phase shifting section are controllably rotatable around a longitudinal axis of said coaxial waveguide; and a processor to control rotation of said input polarizing section, said output polarizing section, and said phase shifting section.

### FIELD OF THE INVENTION

The present application is in the field of wireless power transfer, in particular coaxial waveguide phase shifter arrays for wireless power transfer.

### BACKGROUND OF THE INVENTION

Wireless power transfer to Earth from space-born microwave antennas and solar arrays is a concept dating back to the 1970s, currently typically referred to as Space-Based Solar Power (SBSP) by contemporary space agencies (such as ESA, NASA, JAXA). However, it has yet to be practically implemented due to, for example, the demanding engineering challenges associated with the kilometre-scale structures required both in orbit and on Earth.

### SUMMARY OF THE INVENTION

In general, the present invention may alleviate some of the engineering challenges associated with SBSP and/or introduces a more flexible concept, that of the Worldwide Energy Matrix (WEM), allowing, for example, greatly enhanced connectivity of energy supply around the globe using a wide range of Earth-based energy sources, renewable or otherwise.

According to some embodiments of the present invention there is provided a relay for a beam of wireless power, the relay including: an array of coaxial waveguide elements, each element including: an input polarizing section; an output polarizing section; and a phase shifting section located between the input and output polarizing sections, wherein the input polarizing section, the output polarizing section, and the phase shifting section are controllably rotatable around a longitudinal axis of the coaxial waveguide; and a processor to control rotation of the input polarizing section, the output polarizing section, and the phase shifting section.

In some embodiments, the input and output polarizing sections each include two pairs of diametrically opposed polarizing irises protruding into the waveguide.

In some embodiments, the relay is configured to relay a wireless power beam having free space wavelength λ, and wherein the wireless power beam inside the waveguide has wavelength λg, and wherein each pair of polarizing irises in the input and output polarizing sections is located at a longitudinal distance of λg/8 from another pair of polarizing irises in the respective polarizing section.

In some embodiments, the phase shifting section includes three pairs of diametrically opposed phase shifting irises protruding into the waveguide.

In some embodiments, the relay is configured to relay a wireless power beam having free space wavelength λ, and wherein the wireless power beam inside the waveguide has wavelength Ag, and wherein a central pair of phase shifting irises in the phase shifting section is located at a longitudinal distance of λg/6 from each of the other pairs of phase shifting irises in the phase shifting section.

In some embodiments, the coaxial waveguide elements include an inner portion defined by an inner diameter and an outer portion defined by the portion between the inner diameter and an outer diameter, and wherein the inner portion does not permit propagation of an incident wireless power beam having free space wavelength λ.

In some embodiments, the inner portion is substantially hollow.

In some embodiments, the processor is located inside the inner portion of the coaxial waveguide element.

In some embodiments, the relay further includes an input pilot beam analyzer section adjacent the input polarizing section and an output pilot beam analyzer section adjacent the output polarizing section, each of the input and output pilot beam analyzers being capable of measuring a property of an incident pilot beam and communicating the measured property to the processor, wherein the processor is capable of controlling rotation of the input polarizing section, the output polarizing section, and the phase shifting section based on the measured properties.

In some embodiments, the array of coaxial waveguide elements is a hexagonal array.

In some embodiments, the array of coaxial waveguide elements is a rectilinear array.

In some embodiments, the distance between two adjacent coaxial waveguide elements is between 5.0 mm and 10.0 mm.

In some embodiments, the distance between two adjacent coaxial waveguide elements is between 6.0 mm and 7.0 mm.

In some embodiments, the relay is configured to relay a wireless power beam having free space wavelength λ, and wherein ratio of d/λ is less than 0.7, where d represents the distance between two adjacent coaxial waveguide elements.

In some embodiments, the relay is configured to relay a wireless power beam having free space wavelength λ, and wherein ratio of d/λ is less than 0.6, where d represents the distance between two adjacent coaxial waveguide elements.

In some embodiments, the relay further includes a reflective surface at the end of each coaxial waveguide element.

According to some embodiments of the present invention there is also provided a low earth orbit satellite which includes a relay according to an embodiment of the invention.

According to some embodiments of the present invention, there is also provided a constellation of satellites which includes a plurality of low earth orbit satellites which each include a relay according to an embodiment of the invention.

According to some embodiments of the present invention, there is also provided a satellite which includes a relay according to an embodiment of the invention, wherein the satellite is one of: a geostationary orbit (GEO) satellite, a medium orbit (MEO) satellite, a polar orbit satellite, or a sun synchronous-orbit (SSO) satellite.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of a Worldwide Energy Matrix (WEM) configuration, according to some embodiments of the invention;

FIG. 2 is a schematic diagram of a satellite including a combination of reflective and transmissive phase correcting surfaces, according to some embodiments of the invention;

FIG. 3 is a plot of optimum beam collection efficiency against a parameter c, according to some embodiments of the invention;

FIG. 4A is a square lattice arrangement of coaxial waveguide phase shifter elements, according to some embodiments of the invention;

FIG. 4B is a hexagonal lattice arrangement of coaxial waveguide phase shifter elements, according to some embodiments of the invention;

FIG. 5 schematically shows constituent parts of a coaxial waveguide phase shifter array element, according to some embodiments of the invention;

FIG. 6A shows electric and magnetic field lines for a circular coaxial waveguide TE11 mode, according to some embodiments of the invention;

FIG. 6B shows electric and magnetic field lines for a predominantly horizontally polarised TE11 mode, according to some embodiments of the invention;

FIG. 7 shows a three-relay configuration, according to some embodiments of the invention; and

FIG. 8 shows a block diagram of a computing device which may be used with some embodiments of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

A worldwide energy matrix (WEM) system may include one or a network of ground-based RF phased-array antennas, each one powered by electricity generated from one or a plurality of sources including, for example, solar, wind, wave, hydroelectric and/or geothermal (e.g., renewable energy sources). This electrical energy may be converted to an electromagnetic wave using, for example, solid-state or vacuum tube power amplifier technology, typically operating at microwave frequencies, that can be transmitted into space as a collimated beam via amplitude and phase distributions across the phased array aperture. These ground-based transmitter units may be the transmitter units described in PCT International Application No. PCT/IB2020/060595, International Filing Date Nov. 11, 2020, claiming the benefit of U.S. Provisional Patent Application(s) No. 62/934,511, filed Nov. 12, 2019 and Australian Patent Application No. AU 2019904254, filed Nov. 12, 2019, all of which are hereby incorporated by reference.

A WEM system may further include one or more satellites (e.g., a constellation or configuration of satellites) operating in conjunction with the terrestrial transmitters. The transmitted beam may be electronically steered by the transmitter towards such an orbiting satellite. For example, the satellite may transmit a radio-frequency homing signal giving the ground-based transmitter information on the satellite's location. The homing signal may be generated, for example, by a dedicated antenna system mounted on the orbiting satellite operating at a different frequency and much-reduced power level compared to the power beam. Power may also be transferred in the opposite direction from satellite to Earth with the homing signal generated by the ground-based transmitter to guide the power beam emitted by the satellite. In some embodiments, the homing signal is incorporated into the electromagnetic power beam as a data stream giving simultaneous power and data transfer.

It can be understood that the dimensions of the transmitter antenna may be derived based on the wavelength of the power beam and/or the distance required to be transmitted as a collimated beam to the satellite. Examples of dimensions for terrestrial and satellite-based antenna arrays are presented herein.

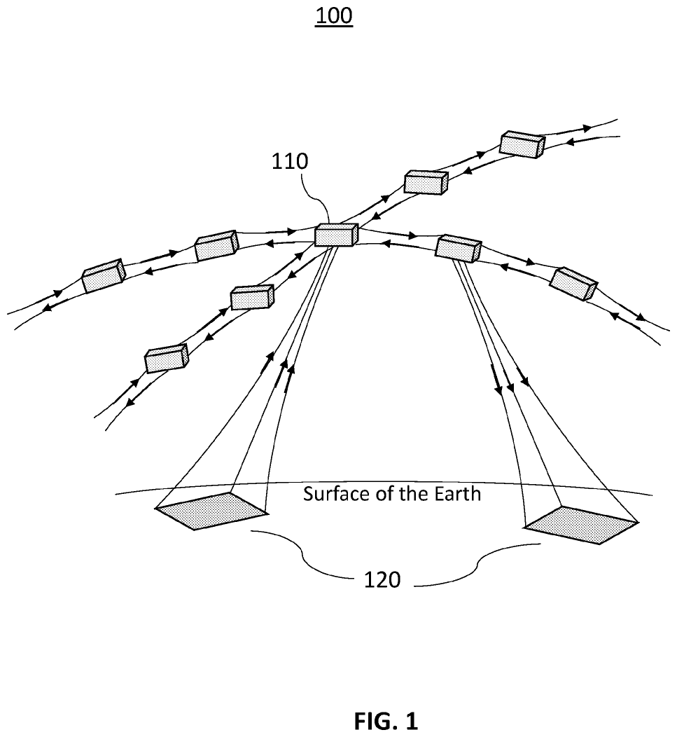

The satellite may receive the incident collimated power beam from the transmitter array using a receiving antenna. Upon receiving the power beam, the satellite may re-direct the power beam (or substantially all of the power beam) to one or more locations, such as one or more satellites in the constellation, or one or more locations back on Earth, or a combination thereof (e.g., power beam splitting). 5 FIG. 1 shows a schematic diagram of a Worldwide Energy Matrix (WEM) configuration 100, according to some embodiments of the invention, and provides an example of the underlying concept, depicting (by way of example) two terrestrial transmitters and nine satellites. Orbiting satellites 110 form a matrix of relay nodes for power beaming from Earth-to-satellite, satellite-to-Earth and/or satellite-to-satellite. Dual-purpose (e.g., transmitter and receiver: transceiver), Earth-based microwave phased array antennas 120 convert ground-based electricity into an electromagnetic beam that is transmitted to an orbiting node (e.g., satellite). The same ground-based antenna may also be able to receive an electromagnetic beam from an orbiting node and convert this into electricity by rectification.

A WEM according to embodiments of the invention may be provided as a constellation of orbiting satellites in one or more different types of orbit. For example, the constellation may include Low Earth Orbit (LEO) satellites, Geostationary Orbit (GEO) satellites, or a combination of LEO and GEO satellites. The constellation may also include one or more satellites having other satellite orbit types, such as a medium Earth orbit (MEO) satellite, a polar orbit satellite, or a sun synchronous-orbit (SSO) satellite. The WEM may include a number of satellites sufficient enough to deliver beamed energy to large tracts of area across the world, for example, across continents or oceans, and/or locations spanning the globe.

Alternatively, a WEM (or a portion thereof) according to some embodiments of the invention may include a plurality of terrestrial transmitters and one satellite, which may act to receive power beamed from a transmitter antenna at a first terrestrial location as well as a transmitter to redirect the power beam to a receive antenna (rectenna) at a second terrestrial location, without forwarding to a second satellite. The satellite may be, for example, a LEO satellite, such as a polar satellite. For example, a single LEO satellite may traverse a circumferential tract of surface area across the face of the globe, and so may receive power from a terrestrial transmitter at a first location (e.g., the North Pole) and may travel to a second location (e.g., the South Pole) and retransmit the power to a terrestrial receiver at the second location.

On Earth, substantially the same phased-array antenna technology used for the transmitter may be used to receive an incoming collimated power beam from any of the space-based satellite platforms. A homing signal may be transmitted from the ground-based receive antenna to the orbiting satellite to guide the beam to its intended destination on Earth.

The incoming electromagnetic beam may be diverted to rectifying circuits that convert the electromagnetic signal back into electricity, for example, into DC electricity that is delivered to an attached load or converted to AC for connection to an existing electricity grid.

Terrestrial antennas as may be used by embodiments of the invention may be dedicated transmitters (e.g., stationed proximate to a power generating source) and others dedicated receivers (e.g., proximate to a load). According to some embodiments of the invention, the same ground-based antenna can be used for both transmitting and receiving functions by using a waveguide-based combiner/splitter network between the antenna radiating elements and its source (for transmitting) or rectifying circuit (for receiving) using microwave engineering components such as circulators, isolators, orthomode transducers, and/or waveguide switches to separate and isolate the incoming from the outgoing wave contributions.

According to some embodiments, the one or more orbiting satellites may include receiving surfaces that incorporate an array of phase-correcting elements that re-direct and/or re-focus (e.g., re-collimate) the incoming beam to its intended target or to the next station (e.g., terrestrial or space based). As discussed further herein, satellites may be equipped with reflective or transmissive phase-correcting surfaces, or a combination of the two.

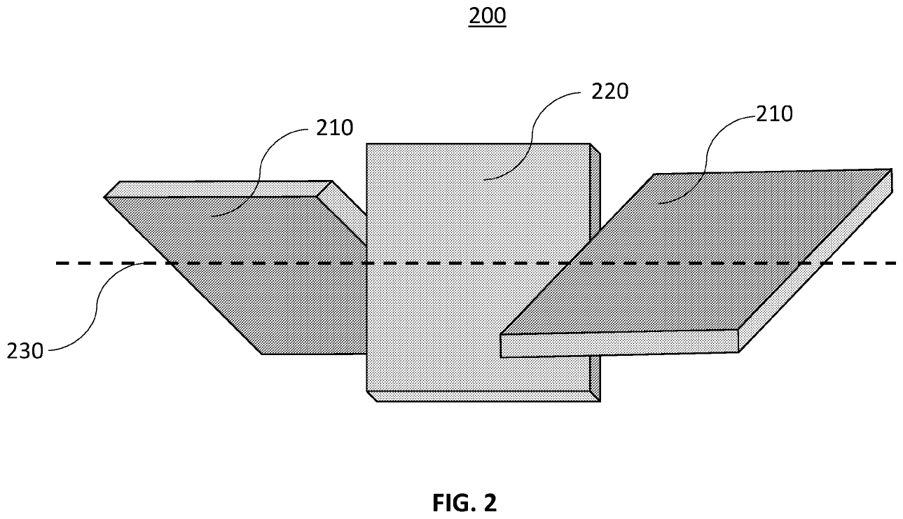

FIG. 2 shows a schematic diagram of a satellite including a combination of reflective and transmissive phase correcting surfaces, according to some embodiments of the invention. A satellite 200 may include reflective phase-correctors 210 for satellite-to-Earth or Earth-to-satellite power beaming. The satellite may also include a bi-directional transmissive phase-corrector 220 for satellite-to-satellite power beaming. The three phase-correctors may share a common axis of rotation 230.

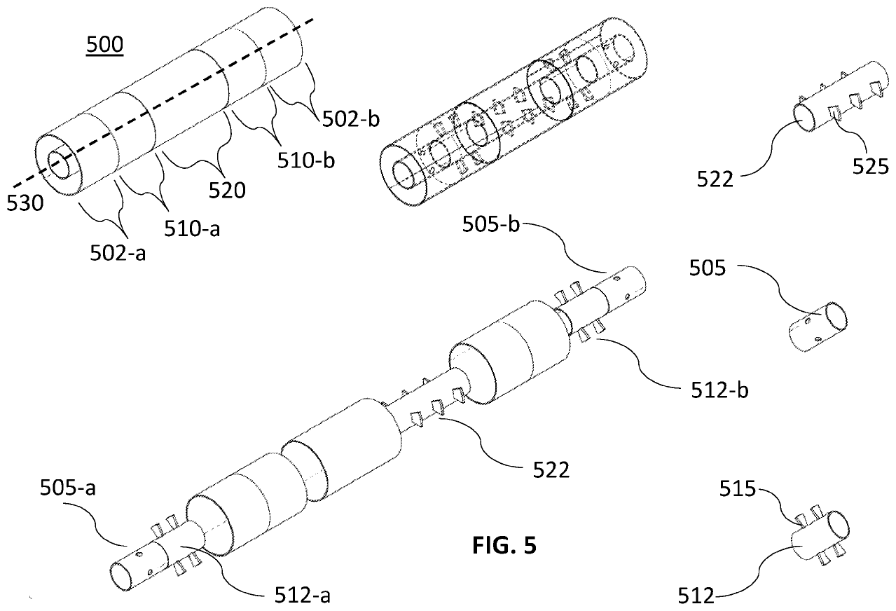

According to some embodiments, one or more reflective phase correctors 210 are used for space-to-Earth and Earth-to-space power beam propagation. The reflective phase corrector may include an array of open waveguide structures (such as a coaxial waveguide element 500 as described further in FIG. 5) terminated by a mechanically adjustable short-circuit end-plate or solid-state electronic device to, for example, achieve a phase shift. The phase of the reflected wave from each array element may give rise to a phase distribution across the exit aperture, which can result in emission at a desired beam direction with desired focusing properties. The location of the intended target may be provided by a homing signal transmitted from the target's location on Earth. A processor on board the satellite may calculate the reflection angle to direct the received energy toward the target and control the parameters of the phased array to do so. According to some embodiments, transmissive phase corrector 220 is used to re-focus the power beam from one satellite to an adjacent one in the same constellation, that is, space-to-space propagation of the power beam. According to some embodiments, a transmissive phase corrector allows passage of the incoming wavefront through it whilst imparting a phase distribution across the exit aperture to focus and steer the outgoing beam. This may be implemented, for example, as a microwave lens with either fixed or configurable phase correction elements across its aperture. Configurable devices are achieved by means of mechanical, electrical or a combination of electrical and mechanical control.

According to some embodiments, there may be provided a satellite including a combination of reflective and transmissive phase correcting surfaces, for example, as shown in FIG. 2, allowing bi-directional beam propagation between satellites and also from satellite-to-Earth and Earth-to-satellite. The three phase-correctors may share a common axis of rotation 230.

The configuration of FIG. 2 may allow a space-born power beam propagating through the orbiting ring of transmissive phase correctors (as shown in the satellite constellation in FIG. 1) to be re-directed to an Earth-based target by steering the beam to impinge on one of the reflective phase correctors. The pair of reflective phase correctors may allow a space-born power beam to be re-directed to Earth from either direction, that is, either clockwise or anti-clockwise around the orbiting ring of satellites.

It should be noted that only small angular deviations of the power beam may be required between satellites or between Earth and satellite. Consequently, it may not be necessary to use a large number of closely spaced phase-shifting elements over the surface of either the transmissive or reflective phase correctors as may be typically implemented in an electronically steered phased array antenna. Small angular deviations of the power beam can be realised by, for example, using a much simpler phase-shifting arrangement that requires only four phase shifters to be used, each phase shifter being applied to one quadrant of the phase corrector's aperture. This can significantly reduce the complexity and cost of the space-born phase shifting mechanism required for small-angle beam steering in the satellite phase correctors.

It can be understood that the shape of the antenna depicted in FIG. 2 is an example, and other antenna array shapes are possible, depending on the implementation. This configuration may be extended to include propagation in the transverse direction by adding a similar arrangement of reflective and transmissive phase correctors above or below that shown in FIG. 2 and mounted at 90 degrees to the former.

For satellites in LEO, each member of the constellation may have a significant relative velocity with respect to an Earth-based observer. As an example, at an altitude of 400 Km, satellites typically move with a velocity of around 7,300 m/s relative to the Earth (˜ Mach 23). As such, these can require real-time tracking by the ground-based transmit/receive antennas in the WEM system. This may be accomplished by, for example, the previously mentioned homing signal in conjunction with electronic beam steering of the antenna array.

For satellites in GEO, the distance to Earth is 36,000 Km and the orbit is synchronised with that of the Earth's rotation with the satellite appearing stationary to an Earth-based observer. Only minor Earth-based beam-steering corrections will typically be anticipated with the GEO configuration.

### Beam Formation in the Near Field

A satellite or relay in a WEM according to some embodiments of the invention may use a radiating near-field beam propagation system. Despite the apparent long distances involved in space-to-Earth beam propagation, it can be nevertheless possible using embodiments of the invention to create a radiating near-field scenario (Fresnel region) that optimises the beam collection efficiency by an appropriate choice of antenna dimensions for a given wavelength and antenna separation distance. EQN. 1 can provide a relationship between the antenna dimensions, wavelength and range in the form of a dimensionless parameter, c, which can be referred to as the Fresnel number. This parameter, c, can be defined by an appropriate amplitude distribution across the antenna aperture, for example, an antenna aperture that maximise the value of beam collection efficiency. The amplitude distribution can be in the form of an angular prolate spheroidal wave function which has the parameter c as its argument. The phase distribution of the electric field over the antenna aperture can be determined by a focused field condition that equalises path lengths from the transmitting antenna elements to the centre of the receiving aperture. Beam collection efficiencies in excess of 99% can be achievable using the present invention by, for example, providing the give Fresnel numbers with values in excess of, for example, 4, thereby the present invention can virtually eliminate energy spill over at the receiving aperture. This can improve the efficiency of the system and/or confine the beam to an area no greater than the antenna size, which can improve system safety in a manner that is typically not achievable with far-field systems.

Beam collection efficiency may be characterized by the dimensionless parameter, c, as defined below in EQN. 1. Beam collection efficiency is typically a key parameter in spheroidal wave function theory to specify the optimum amplitude taper for a square transmitting antenna of dimension, Dₜ, focused onto a receiving aperture of dimension, Dᵣ, for a range R and a wavelength Δ:

$$c = \frac{π {D}_{t} {D}_{r}}{2 λ R} \qquad EQN . 1$$

Spheroidal wave functions can have highly advantageous properties for wireless power transfer due to the fact that they are eigenfunctions of the Fourier integral, and so can transform into the same functional form.

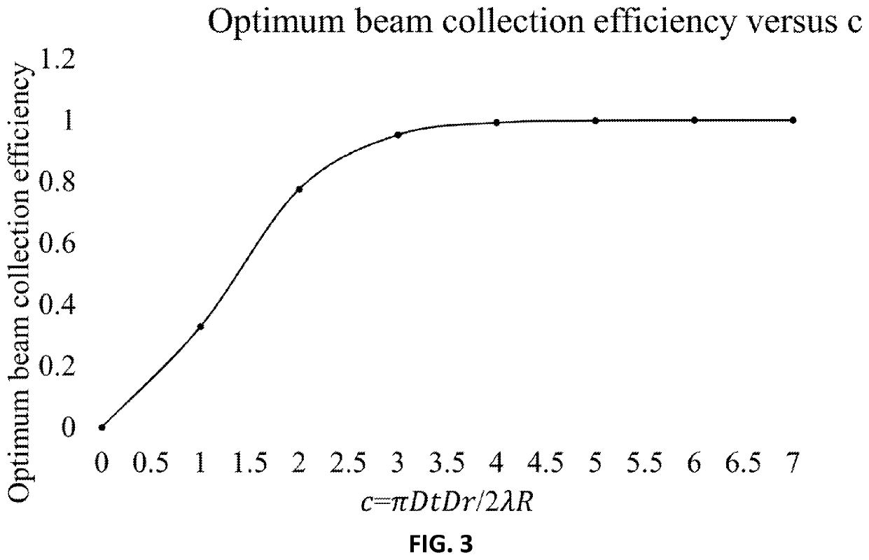

FIG. 3 is a plot of optimum beam collection efficiency against the parameter c, according to some embodiments of the invention. As can be seen, beam collection efficiency may increase with increasing values of c. Values of c≥4 give beam collection efficiencies in excess of 99%.

Presented now are some examples of antenna and orbiting phase-corrector dimensions.

Assume an example of the frequency as 5.8 GHz (wavelength˜52 mm), a square ground-based antenna with dimension 1000 m can be capable of producing a condensed beam spot diameter of ˜100 m at a distance of 400 Km (e.g., LEO altitudes) with beam collection efficiency of ˜99.9%. A size of 100 m is approximately equivalent to that of the existing International Space Station (ISS).

In this example, the 100 m diameter satellite aperture may then be used to re-focus the beam to an adjacent satellite with the same receiving aperture dimension using the same optimised amplitude and phase tapers as used in the Earth-to-space uplink. For this size of satellite aperture (100 m) power can be beamed to an adjacent satellite at a distance of ˜50 Km with a beam collection efficiency of ˜99.9%.

For a GEO-based configuration, optimum beam forming for a range of ˜36,000 Km and same-sized square transmitting and receiving apertures can result in an antenna dimension of 2200 m for a beam collection efficiency of ˜99%. By increasing the size of the transmitting antenna on Earth to 9500 m, the receiving aperture size in orbit can be reduced to 950 m whilst maintaining the same beam collection efficiency of 99%.

or satellite-to-satellite beam propagation for this example GEO configuration, the 950 m diameter exit aperture from the satellite can permit beam propagation over a distance of 6700 Km (between satellites) whilst maintaining a beam collection efficiency of 99%. The effect of beam focusing, enabled in the near-field, can allow the size of the receiving aperture (e.g., that of the satellite in orbit) to be greatly reduced compared to the transmitting aperture which can help to significantly reduce launch and deployment costs for space-born hardware. This is embodied in the dimensionless ratio denoted by the parameter, c, in EQN. 1 which can permit different sized receiving and transmitting antennas to be used whilst still maintaining a value of c consistent with high beam collection efficiencies (see FIG. 3).

Accordingly, the Worldwide Energy Matrix (WEM) can include creation and control of steerable, collimated microwave beams as a means to realise efficient long-range wireless power transfer between transmitting and receiving locations.

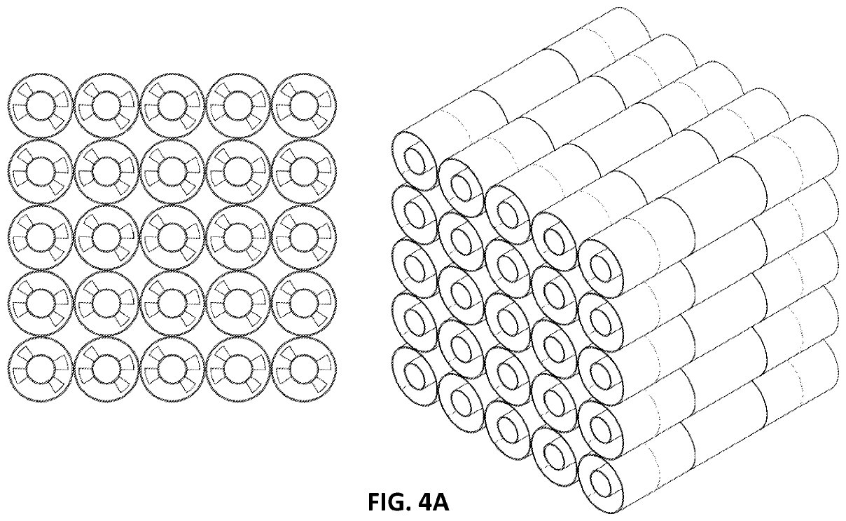

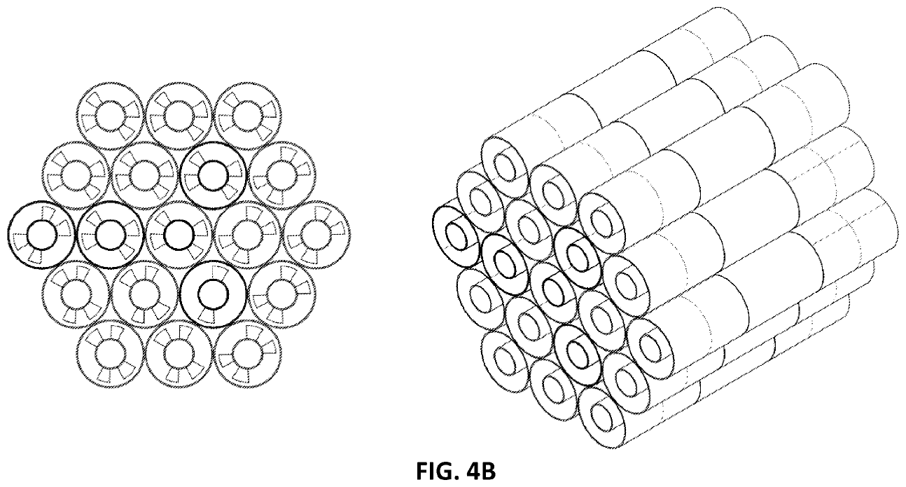

Embodiments of the invention may include the use of intermediate orbiting relays to re-direct a power beam from one location to another. Each relay may include at least one large aperture, e.g., planar, incorporating beam steering and beam forming functionality in either a reflective or transmissive mode. Such a structure may be implemented using a plurality of nominally identical phase shifting elements arranged into a periodic lattice spanning a planar surface. In various embodiments, the lattice geometries are square or hexagonal as shown in FIGS. 4A and 4B, respectively. Assembling multiple elements into an array using modular, or element-wise construction, may facilitate ease of assembly in space (such as by unmanned means using robotics) and may keep payload sizes down (e.g., both in terms of physical dimensions and mass), thereby reducing launch and deployment costs (e.g., launch fuel efficiency).

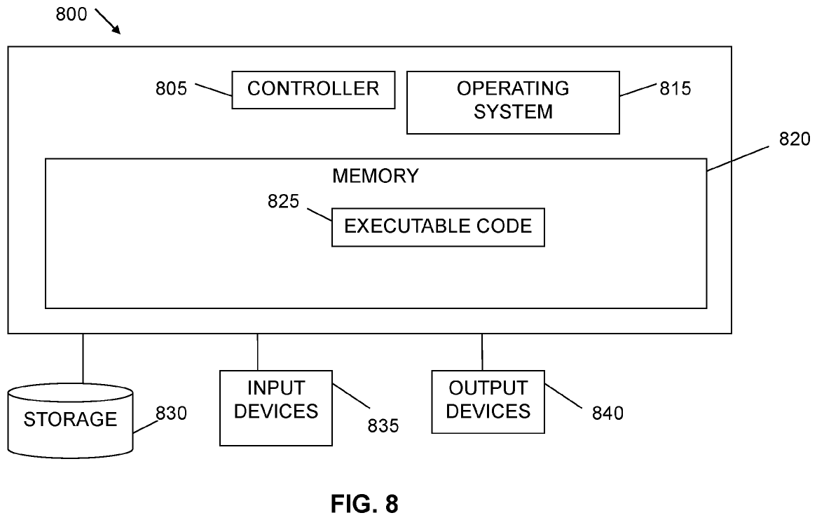

FIG. 5 schematically shows constituent parts of a relay, according to some embodiments of the invention. A relay for a beam of wireless power according to some embodiments of the invention may include an array of coaxial waveguide elements 500. Each element 500 may include: an input polarizing section 510-a; an output polarizing section 510-b; and a phase shifting section 520 located between said input and output polarizing sections 510-a and 510-b, respectively. The input polarizing section 510-a, output polarizing section 510-b, and phase shifting section 520 may be controllably rotatable around a longitudinal axis 530 of the coaxial waveguide element 500. A processor (e.g., processor 805 as described below in FIG. 8) may be used to control rotation of the input polarizing section 510-a, the output polarizing section 510-b, and the phase shifting section 520.

In some embodiments, the array of coaxial waveguide elements 500 is a hexagonal array (e.g., as shown in FIG. 4B). In some embodiments, the array of coaxial waveguide elements is a rectilinear array (e.g., as shown in FIG. 4A). An array of a plurality of coaxial waveguide elements 500 may form a relay for a beam of wireless power. For example, arrays can have hundreds to hundreds of millions of coaxial waveguide elements 500.

In some embodiments, a distance between two adjacent coaxial waveguide elements (e.g., between elements 500 in an array such as in FIGS. 4A and/or 4B) is between 5.0 mm and 10.0 mm. In some embodiments, the distance between two adjacent coaxial waveguide elements is between 6.0 mm and 7.0 mm. The distance between adjacent elements may be less than one free-space wavelength, for example half a wavelength. This may ensure that the array does not produce additional diffraction orders (e.g. grating lobes) when in operation.

When illuminated by an incident power beam, a relay according to some embodiments of the invention may be used to alter the beam direction and focal properties of the beam by controlling the phase of the reflected or transmitted wavefront. Each phase shifting element in the relay array can be designed to be adjustable over a range of phase shifts from 0 to 360 degrees, thereby offering complete control of the emerging wavefront.

A phase distribution for a particular relay aperture can be determined by a pair of pilot beam waveforms emitted by the source and target apertures. Each pilot beam can illuminate one side of the relay surface. Each pilot beam may be generated by an electrically small radiating element placed at the centre of the receiving/transmitting aperture. Electrically small may mean an antenna that has dimensions that are comparable to, or less than, the operating wavelength. The electrically small radiating element can emit a spherical wavefront at the same frequency and polarisation as the power beam but with lower power and with a direction that is nominally towards one surface of the relay aperture. Alternatively, a spherical wavefront of the pilot beam can be achieved using any antenna that is in the far-field (Fraunhofer region) of its intended target aperture, that is, at a range greater or equal to 2D2/1, where D is the largest dimension of the pilot beam radiating antenna and 1 the wavelength.

The relay elements may measure the polarisation of the incoming pilot beams. The relay can measure the phase difference between the two pilot beams at each element of the array, and determine correct phase shift information to re-direct and/or re-focus the power beam from the source to its intended target.

The relay can operate in a transmissive mode of operation for the relay (e.g., akin to a lens) that can allow a phase delay or phase advance distribution to be implemented across the array of phase shifters whilst offering minimal power loss within the relay. The latter can involve a high degree of impedance matching to minimise reflections from the relay and the use of high-conductivity materials (e.g., metals) to minimise heat dissipation.

The relay can operate in a reflection mode that can allow an output port of the phase shifter to be terminated in a purely reflective surface (e.g., short circuit) such that the outgoing wavefront undergoes total reflection but with a different phase delay/advance induced across the emerging beam so as to steer and re-focus the beam to a different location. In some embodiments, the relay includes a reflective surface at one end of each coaxial waveguide element.

Transmissive and/or reflective modes of operation for the relay can require an adjustable phase shifting element that can be low-loss (e.g. less than 0.1 dB transmission loss) and able sufficient to phase shift at the required incident microwave power levels which may be tens to hundreds of Watts per phase shifting element or even up to 1 kW. To satisfy these design aims, such phase shifting elements may include passive, high electrical conductivity metallic elements placed in an air or vacuum-filled waveguide, with no active electronics (semiconductors) or lossy materials (such as ferrites or dielectrics) placed in the path of the microwave beam. Such a phase-shifting structure is described in the following section and may be based on a coaxial waveguide configuration. For space-borne and air-borne applications, also it can be desirable to have a structure that is lightweight yet mechanically stiff. Such a structure may be achieved by using elements that are substantially hollow (to reduce weight) and then assembled into a honeycomb-like array to provide high mechanical stiffness. Honeycomb structures are commonplace in aerospace applications where low weight and high stiffness are attributes required within the same structure.

### Coaxial Waveguide Phase Shifter Element

The principle of operation for the proposed phase shifter according to embodiments of the invention is based on a length of metallic waveguide consisting of two circular, coaxial cylinders. One benefit of using a coaxial waveguide element (e.g., element 500 as shown in FIG. 5), as opposed to a more conventional hollow circular cylinder, can be in being able to achieve a smaller element separation when multiple waveguides are assembled side-by-side into an array as required to form the relay structure.

When considering the beam-steering and beam-forming performance limitations of a periodic array of phase-shifting elements, the inter-element spacing, d, relative to the operating wavelength, λ, can be considered. Typically, the smaller the value of d/λ, the wider is the range of possible relay beam scanning angles that are free from grating lobes.

In some embodiments, the relay is configured to relay a wireless power beam having free space wavelength λ, wherein the ratio of d/λ is less than 0.7, where d represents the distance between two adjacent coaxial waveguide elements. In some embodiments the ratio of d/λ is less than 0.6. In some embodiments, the distance between two adjacent coaxial waveguide elements (e.g., between elements 500 in an array) is between 5.0 mm and 10.0 mm. In some embodiments, the distance between two adjacent coaxial waveguide elements is between 6.0 mm and 7.0 mm. When arranged in a large periodic array (typically with a square or hexagonal lattice, as shown for example in FIGS. 4A and 4B), a cylindrical coaxial waveguide element can support a transverse electric mode with modal indices m=n=1 (e.g., TE11). This can be excited in the region between inner and outer conductors. The TE11 mode is not the fundamental mode for a coaxial waveguide of this type, that being the radially symmetric transverse electromagnetic mode (e.g., TEM). However, when the array is illuminated by an incoming plane wave, the array symmetry can prevent the TEM from being excited and the higher-order TE11 mode can be produced in the space between conductors.

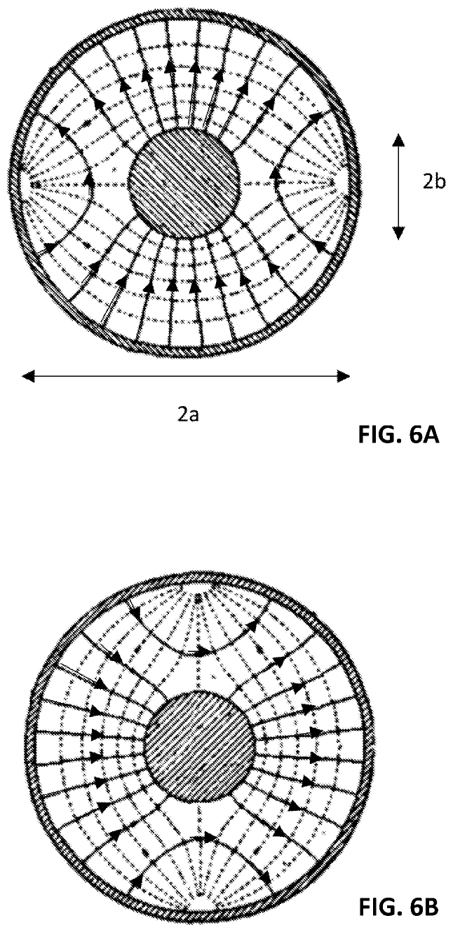

FIG. 6A shows electric and magnetic field lines for a circular coaxial waveguide TE11 mode, according to some embodiments of the invention. FIG. 6B shows electric and magnetic field lines for a predominantly horizontally polarised TE11 mode, according to some embodiments of the invention.

The inner and outer radii of the coaxial waveguide denoted by b, a respectively, can be set such that the TE11 mode can propagate through the waveguide without being cut-off at the operating frequency. The cut-off wavelength, Δ_{c11}, for the TE11 mode of a circular coaxial waveguide is approximately given by the mean circumference of the two cylindrical conductors, that is, Δ_{c11}≈π(a+b). The minimum element spacing in an array of such waveguides can be approximately equal to the outer diameter d=2a, as shown in FIG. 6A

Assuming a circular waveguide supporting a TE11 circular waveguide mode operating at the same frequency and having the same waveguide wavelength as its coaxial waveguide counterpart supporting its own TE11 coaxial mode, then the diameter of this circular waveguide element is given by D=1.841 (a+b).

Thus, the coaxial waveguide element can provide a more compact array spacing with respect to the wavelength than a circular waveguide with the same propagation characteristics. As an example, consider a frequency of 14 GHz (wavelength in free space=21.4 mm) for a coaxial waveguide with a=6.225 mm and b=2.905 mm. The ratio d/λ=0.58 in this instance. A circular waveguide with the same propagation constant at the same frequency would have a diameter D=16.8 mm giving a ratio D/1=0.77.

The TE11 mode can have two independent orthogonal polarisation states within the coaxial waveguide. One state has its electric field predominantly vertically polarised with maxima at 12 o'clock and 6 o'clock, and field nulls at 9 o'clock and 3 o'clock. The other state has its electric field predominantly horizontally polarised with maxima at 3 o'clock and 9 o'clock and nulls at 12 o'clock and 6 o'clock. (See FIGS. 6A and 6B). This dual polarised mode spectrum can assist in the operation of the phase shifter.

In some embodiments, the region of the coaxial waveguide for which the radius is less than that of the inner conductor, b, can be left completely hollow and does not need to be enclosed with metal endcaps or made from solid material. Mechanically, the coaxial waveguide can provide a very lightweight structure with high stiffness when incorporated into a tightly packed array of elements akin to a honeycomb structure. It is therefore well suited to airborne and space-borne applications for which weight reduction is a strong and highly desirable design aim.

From an electromagnetic viewpoint, the innermost hollow cylindrical region forms a circular waveguide that is cut-off at the operating frequency. The diameter of the circular waveguide can be too small to permit even the lowest order waveguide mode to propagate. Only the coaxial region between the outer and inner conductors permits wave propagation. The middle of the hollow region can be completely shielded from any incident microwave radiation. This can be used to advantage since it can provide a suitable location for electronics, mechanical or electromechanical devices that avoid interference with, or from, the incident microwave power beam.

For example, according to some embodiments of the invention, the coaxial waveguide elements include an inner portion defined by an inner diameter and an outer portion defined by the portion between the inner diameter and an outer diameter, wherein the inner portion does not permit propagation of an incident wireless power beam having free space wavelength λ. In some embodiments the inner portion is substantially hollow. In such embodiments where the inner portion is substantially hollow, a processor (e.g., a processor for controlling rotation of the polarising and phase shifting sections) may be located inside the inner portion of the coaxial waveguide element.

The use of passive waveguide structures to achieve phase shifting, as opposed to using active semiconductor devices, is two-fold: (1) it can enable insertion losses to be kept very low (less than 0.1 dB) due to, for example, the use of well-matched, metallic elements; and (2) it can enable high levels of incident microwave power to be handled, (e.g. tens to hundreds of Watts, up to 1 kW), well beyond that possible with semi-conductors.

To implement a phase shifting element, the length of coaxial waveguide may be divided into five parts which are cascaded in series. With reference to FIG. 5, the sections are:
(i) A ‘pilot-wave analyzer’ section (502-a) including of a polarisation sensor and phase detector for analysis of one (of two) pilot waves incident on one side of the relay;
(ii) An input polariser section (510-a) that converts an incoming linearly polarised wave into circular polarisation;
(iii) A central section (520) that imparts a phase shift on the circularly polarised output from the input polariser section as a function of its rotation angle with respect to the other sections;
(iv) An output polariser section (510-b) that converts the phase-shifted circularly polarised output from the central section back into a linearly polarised wave of the same polarisation as the input wave; and
(v) A second pilot-wave analyzer section (502-b) identical to that in (i) but intended for use with the second pilot wave illuminating the other side of the relay.

These components are now discussed in further detail.

### Pilot-Wave Analyzer

In some embodiments, pilot waves are used to provide phase and polarisation information for determining an angular orientation for the polariser and phase shifting sections.

The pilot beam can be emitted by a low-power emitter emitting electromagnetic radiation generated by a small antenna located in the centre of each relay aperture, each ground-based transmitter and/or receiver aperture. The pilot beam can generate a spherical wavefront at the same frequency and polarisation as the power beam that impinges on an adjacent relay surface. The spherical wavefront illuminating one surface of a relay can mimic that of a point source emitter located at the centre of the emitting relay/antenna aperture. This wavefront may contain information about the polarisation of the illuminating power beam and also the phase shifter settings across the relay aperture that can be imparted on the beam to focus and steer the power beam to its intended target.

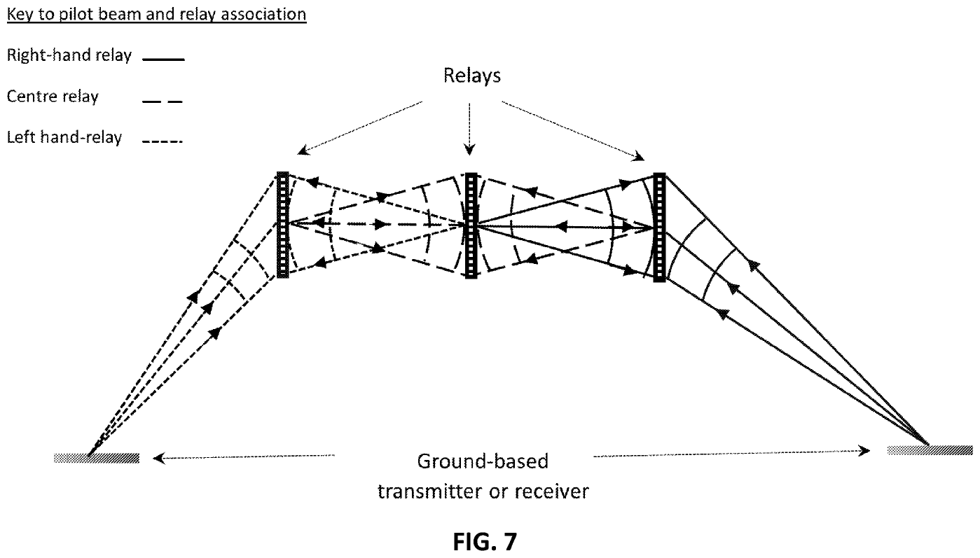

Two separate pilot beams can be used for a single relay-one pilot beam can illuminate one side of the relay aperture and the remaining pilot beam can illuminate the other side. A three-relay example is depicted in FIG. 7 that shows two pilot beams for each of the relays shown, with both sides of the relay illuminated by a respective pilot beams.

The pilot-beam analyzer sections 502-a, 502-b may be incorporated into the first and last sections of the phase-shifter device 500 and may serve to determine the polarisation of the incoming pilot beam and the phase difference between the two pilot beams that illuminate either side of the relay surface.

In some embodiments, a pair of directional couplers 505 built into the inner conductor of the coaxial waveguide are used throughout the entire structure. The directional couplers may include small coupling apertures placed within a waveguide wall that sample a small amount of the wave that is propagating in the waveguide in a single direction and not in the reverse direction. The directional couplers can be directional couplers as are known in the art.

For example, two directional couplers may be used within each pilot-wave analyzer-one coupler may be mounted at 90 degrees to the other around the circumference of the inner conductor so as to be sensitive to two orthogonal polarisations of the incoming wave.

The output from each directional coupler may be fed to a microwave circuit that resides within the hollow interior of the inner conductor of the coaxial waveguide. The polarisation of the incoming pilot beam may be determined by measuring the relative amplitudes of each orthogonal pair of couplers. The polarisation of the incoming pilot beam may be used to control the rotary position of the two polariser sections (e.g., 510-a, 510-b) so as to orientate the polariser to the correct 45-degree angle with respect to the incident electric field vector.

The phase difference between the two pilot beams illuminating each face of the relay may be measured by a microwave phase comparator circuit also mounted within the hollow interior of the coaxial waveguide. The phase comparator circuit can use the microwave outputs from directional couplers at each end of the coaxial structure to determine the phase difference between pilot beams. This phase difference information may be used to control the rotary motion of the central phase shifting section so as to correctly focus the incoming power beam onto its intended target aperture. Focusing the beam may be equivalent to equalising the path lengths through each coaxial waveguide element of the relay in the manner of a lens.

A relay according to some embodiments of the invention further includes an input pilot beam analyzer section 502-a adjacent to the input polarizing section 510-a and an output pilot beam analyzer section 502-b adjacent to the output polarizing section 510-b, each of said input and output pilot beam analyzers 502-a, 502-b being capable of measuring at least one property of an incident pilot beam and communicating the at least one measured property to the processor, wherein the processor is capable of (e.g., configured to) controlling rotation of the input polarizing section 510-a, the output polarizing section 510-b, and the phase shifting section 520 based on the at least one measured property.

### Polariser

The two polariser sections (ii) and (iv) (e.g., input and output polarizing sections 510-a and 510-b) may be identical in construction (e.g., 512). The creation of a circularly polarised wave from a linearly polarised input is provided by introducing two pairs of diametrically opposed iris sections between the inner and outer conductor of the coaxial waveguide as shown in FIG. 5.

For example, in a relay according to some embodiments of the invention, the input and output polarizing sections each include two pairs of diametrically opposed polarizing irises (collectively referenced 512) protruding into (e.g., open to) the waveguide 500.

The irises 512 themselves may include narrow angular wedges 515 that interact with the TE11 mode in the waveguide in different ways depending on the polarisation of the incoming mode spectrum. Two pairs of diametrically opposed polarizing irises can give rise to four (e.g., 2×2) narrow angular wedges, as can be seen in FIG. 5. The incoming linearly polarised input may be decomposed into two orthogonally polarised TE11 modes, the relative amplitude of each mode can be a function of the orientation of the incident electric field. If the polarisation orientation of the incoming linearly polarised wave is determined by means of the pilot-wave analyzer described herein (see (i) and (v)), the position of the iris elements in the input polariser are at 45 degrees to the incoming wave, a circularly polarised output may be obtained.

By arranging the irises at 45 degrees to the incoming polarisation vector, the incident TE11 coaxial waveguide mode may be split with equal magnitude into its two orthogonal polarisation states. The two modes that result may be orientated such that one mode has its electric field maxima coincident with the irises, and the orthogonal mode with its electric field nulls coincident with the irises.

In the latter case, the irises can have virtually no effect on the TE11 mode, and this component of the wave propagates unimpeded with a phase shift determined purely by the phase velocity of the coaxial waveguide and its length.

In the former case, the irises may interact strongly with the co-polarised component of the TE11 mode and act as shunt susceptance elements whose effect is readily determined by well-known transmission line models such as the ABCD matrix method. By careful design of the iris element geometry and correct choice of separation between each iris pair along the waveguide axis, the phase shift for this component of the TE11 mode may be made 90 degrees out-of-phase with the orthogonal TE11 mode component, and simultaneously be impedance matched to give no reflected wave. Thereby, circular polarisation is achieved at the output of the polariser section by virtue of the two equal-amplitude waveguide modes being 90 degrees out of phase.

In FIG. 5, the individual irises 515 of the polarising irises (e.g., 512-a and 512-b) may be separated from each other by one eighth of a waveguide wavelength (λ_{g}/8) with the equivalent normalised shunt susceptance for the iris pair, b₁=2, for one polarisation state, and b₁=0 for the orthogonal mode. This can produce a phase difference of 90 degrees between the two TE11 mode components whilst achieving a reflectionless structure for both polarisation states.

According to some embodiments, the relay is configured to relay a wireless power beam having free space wavelength λ, wherein the wireless power beam inside the waveguide has wavelength λg, and wherein each pair of polarizing irises in the input and output polarizing sections is located at a longitudinal distance of λg/8 from another pair of polarizing irises in the respective polarizing section.

In various embodiments, three or more irises are used which may increase the overall device length, increase complexity, and/or may increase dissipative losses.

### Phase Shifting Section

For example, the central section 520 of the coaxial waveguide element may impart a phase shift that can be varied between 0 and 360 degrees by rotating the inner conductor with respect to the other sections. The phase shift may be achieved by three pairs of diametrically opposed irises connected to the inner conductor each having a similar (e.g., identical or not identical) wedge shape 525 to those used in the polariser sections (e.g., wedge shapes 515). As can be seen in FIG. 5, three pairs of diametrically opposed irises results in six (e.g., 3×2) wedges 525. In the phase shifter shown in FIG. 5, the central section irises (collectively referenced 522) are wedges (e.g., wedges 525) and are separated from each other along the waveguide longitudinal axis 530 by a distance equal to one sixth of a waveguide wavelength (λ_{g}/6). The irises can cause a different phase shift for electric field components parallel and perpendicular to the longitudinal plane containing the irises. The irises can be impedance matched for both parallel and perpendicular polarised fields with a phase difference of 180 degrees between the two states being the aim. For the parallel polarised case, the equivalent normalised shunt susceptance of each iris pair is given by b₂=2.31, and for the perpendicular case, b₂=0. The resultant output from the central section is a reflectionless circularly polarised wave having a phase shift of θ/2 degrees with respect to the circularly polarised input where 0 is the angle of rotation of the inner cylinder.

In a relay according to some embodiments of the invention, the phase shifting section includes three pairs of diametrically opposed phase shifting irises protruding into (e.g., open to) the waveguide. The relay may be configured to relay a wireless power beam having free space wavelength λ, wherein the wireless power beam inside the waveguide has wavelength λg, and wherein a central pair of phase shifting irises in the phase shifting section is located at a longitudinal distance of λg/6 from each of the other pairs of phase shifting irises in the phase shifting section.

In various embodiments, other combinations of iris shunt susceptances are used for the central phase shifting section. To maintain a reflectionless (e.g., impedance-matched) structure, the two outermost pairs of irises of the three can be identical in design and the central iris chosen to have a susceptance giving a matched state for the particular longitudinal separation between irises. The design shown in FIG. 5 represents a particularly simple and compact structure in terms of its overall length by utilising three identical pairs of irises spaced Δ_{g}/6 apart.

In some embodiments, rotation of the central phase shifting section 520 is achieved by electromechanical means, for example using a brushless electric motor. The iris sections within the coaxial region may be made of magnetic material that form the stator of a switched reluctance motor design. Applying an external magnetic field via small electromagnets mounted around the circumference of the innermost hollow region which are activated in a switched sequence provides a means of activating the rotary motion required for the phase shifter. Rotary motion for the polariser sections may also be realised in a similar way to that of the phase shifter section.

Any active components used in the phase shifter array element that require a DC electrical supply, such as electric motors and sensing electronics, may obtain the required power from a variety of possible sources within the array. Examples include, solar-powered photovoltaics or rectified microwave power gleaned from the incident power beam via rectenna elements built into the array. Accordingly, the need for batteries (with finite storage/recharge lifetime) is eliminated, and also reduces the overall weight which is an important consideration for aerial/space borne platforms.

FIG. 8 shows a block diagram of an exemplary computing device which may be used with embodiments of the present invention. Computing device 800 may include a controller or computer processor 805 that may be, for example, a central processing unit processor (CPU), a chip or any suitable computing device, an operating system 815, a memory 820, a storage 830, input devices 835 and output devices 840 such as a computer display or monitor displaying for example a computer desktop system.

Operating system 815 may be or may include code to perform tasks involving coordination, scheduling, arbitration, or managing operation of computing device 800, for example, scheduling execution of programs. Memory 820 may be or may include, for example, a Random Access Memory (RAM), a read only memory (ROM), a Flash memory, a volatile or non-volatile memory, or other suitable memory units or storage units. At least a portion of Memory 820 may include data storage housed online on the cloud. Memory 120 may be or may include a plurality of different memory units. Memory 120 may store for example, instructions (e.g., code 825) to carry out methods as disclosed herein, for example for controlling a rotation of one or more elements of a coaxial waveguide according to embodiments of the invention. Memory 820 may use a datastore, such as a database.

Executable code 825 may be any application, program, process, task, or script. Executable code 825 may be executed by controller/processor 805 possibly under control of operating system 815. For example, executable code 825 may be, or may execute, one or more applications performing methods as disclosed herein, such as controlling rotation of the input polarizing section, the output polarizing section, and the phase shifting section. In some embodiments, more than one computing device 800 or components of device 800 may be used. One or more processor(s) 805 may be configured to carry out embodiments of the present invention by for example executing software or code.

Storage 830 may be or may include, for example, a hard disk drive, a floppy disk drive, a compact disk (CD) drive, a universal serial bus (USB) device or other suitable removable and/or fixed storage unit. Data described herein may be stored in storage 830 and may be loaded from storage 830 into a memory 820 where it may be processed by controller 805. Storage 830 may include cloud storage. Storage 830 may include storing data in a database.

Input devices 835 may be or may include a mouse, a keyboard, a touch screen or pad or any suitable input device or combination of devices. Output devices 840 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 835 and/or output devices 840.

Embodiments of the invention may include one or more article(s) (e.g., memory 820 or storage 830) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

A processor for functional control of one or more elements described herein, such as for controlling rotation of one or more elements, may be coupled to a computer readable data storage containing instructions (such as code) which may facilitate one or more calculations required for determining the required rotation. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fibre cable, RF, etc., or any suitable combination of the foregoing. Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages (e.g., Fortran). The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. The principles and uses of the teachings of the present invention may be better understood with reference to the accompanying description, figures, and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers. If the specification or claims refer to “an additional” element, that does not preclude there being more than one of the additional element. It is to be understood that, where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A relay for a beam of wireless power comprising:
an array of coaxial waveguide elements, each element including:
an input polarizing section,
an output polarizing section, and
a phase shifting section located between said input and output polarizing sections,
wherein said input polarizing section, said output polarizing section, and said phase shifting section are controllably rotatable around a longitudinal axis of said coaxial waveguide; and
a processor to control rotation of said input polarizing section, said output polarizing section, and said phase shifting section.

2. The relay of claim 1, wherein said input and output polarizing sections each include two pairs of diametrically opposed polarizing irises protruding into the waveguide.

3. The relay of claim 2, wherein the relay is configured to relay a wireless power beam having free space wavelength λ, and wherein the wireless power beam inside the waveguide has wavelength λg, and wherein each pair of polarizing irises in the input and output polarizing sections is located at a longitudinal distance of λg/8 from another pair of polarizing irises in the respective polarizing section.

4. The relay of claim 1, wherein said phase shifting section includes three pairs of diametrically opposed phase shifting irises protruding into the waveguide.

5. The relay of claim 4, wherein the relay is configured to relay a wireless power beam having free space wavelength λ, and wherein the wireless power beam inside the waveguide has wavelength λg, and wherein a central pair of phase shifting irises in the phase shifting section is located at a longitudinal distance of λg/6 from each of the other pairs of phase shifting irises in the phase shifting section.

6. The relay of claim 1, wherein the coaxial waveguide elements comprise an inner portion defined by an inner diameter and an outer portion defined by the portion between the inner diameter and an outer diameter, and wherein the inner portion does not permit propagation of an incident wireless power beam having free space wavelength λ.

7. The relay of claim 6, wherein the inner portion is substantially hollow.

8. The relay of claim 6, wherein the processor is located inside the inner portion of the coaxial waveguide element.

9. The relay of claim 1, further comprising an input pilot beam analyzer section adjacent the input polarizing section and an output pilot beam analyzer section adjacent the output polarizing section, each of said input and output pilot beam analyzers being capable of measuring a property of an incident pilot beam and communicating said measured property to said processor, wherein said processor is capable of controlling rotation of said input polarizing section, said output polarizing section, and said phase shifting section based on said measured properties.

10. The relay of claim 1, wherein the array of coaxial waveguide elements is a hexagonal array.

11. The relay of claim 1, wherein the array of coaxial waveguide elements is a rectilinear array.

12. The relay of claim 1, wherein the distance between two adjacent coaxial waveguide elements is between 5.0 mm and 10.0 mm.

13. The relay of claim 1, wherein the distance between two adjacent coaxial waveguide elements is between 6.0 mm and 7.0 mm.

14. The relay of claim 1, wherein the relay is configured to relay a wireless power beam having free space wavelength λ, and wherein ratio of d/λ is less than 0.7, where d represents the distance between two adjacent coaxial waveguide elements.

15. The relay of claim 1, the relay is configured to relay a wireless power beam having free space wavelength λ, and wherein ratio of d/λ is less than 0.6, where d represents the distance between two adjacent coaxial waveguide elements.

16. The relay of claim 1, further comprising a reflective surface at one end of each coaxial waveguide element.

17. A low earth orbit satellite comprising the relay of claim 1.

18. A constellation of satellites comprising a plurality of low earth orbit satellites according to claim 17.

19. A satellite comprising the relay of claim 1, wherein the satellite is one of: a geostationary orbit (GEO) satellite, a medium orbit (MEO) satellite, a polar orbit satellite, or a sun synchronous-orbit (SSO) satellite.

20. The relay of any of claim 1, wherein said phase shifting section includes three pairs of diametrically opposed phase shifting irises protruding into the waveguide.

21. The relay of any of claim 1, wherein the coaxial waveguide elements comprise an inner portion defined by an inner diameter and an outer portion defined by the portion between the inner diameter and an outer diameter, and wherein the inner portion does not permit propagation of an incident wireless power beam having free space wavelength λ.

22. The relay of any of claim 6, wherein the processor is located inside the inner portion of the coaxial waveguide element.

23. The relay of any of claim 1, further comprising an input pilot beam analyzer section adjacent the input polarizing section and an output pilot beam analyzer section adjacent the output polarizing section, each of said input and output pilot beam analyzers being capable of measuring a property of an incident pilot beam and communicating said measured property to said processor, wherein said processor is capable of controlling rotation of said input polarizing section, said output polarizing section, and said phase shifting section based on said measured properties.

24. The relay of any of claim 1, wherein the array of coaxial waveguide elements is a hexagonal array.

25. The relay of any of claim 1, wherein the array of coaxial waveguide elements is a rectilinear array.

26. The relay of any of claim 1, wherein the distance between two adjacent coaxial waveguide elements is between 5.0 mm and 10.0 mm.

27. The relay of any of claim 1, wherein the distance between two adjacent coaxial waveguide elements is between 6.0 mm and 7.0 mm.

28. The relay of any of claim 1, wherein the relay is configured to relay a wireless power beam having free space wavelength λ, and wherein ratio of d/λ is less than 0.7, where d represents the distance between two adjacent coaxial waveguide elements.

29. The relay of any of claim 1, wherein the relay is configured to relay a wireless power beam having free space wavelength λ, and wherein ratio of d/λ is less than 0.6, where d represents the distance between two adjacent coaxial waveguide elements.

30. The relay of any of claim 1, further comprising a reflective surface at one end of each coaxial waveguide element.

31. (canceled)

32. (canceled)

33. (canceled)
